(19) United States
(12) Patent Application Publication
(10) Pub. No.: US 2013/0082547 A1
(43) Pub. Date: Apr. 4, 2013

(54) SEALING RESIN COMPOSITION FOR HDD MOTOR AND HDD MOTOR FABRICATED BY USING THE SAME

(71) Applicants: Kun Kim, Suwon (KR); Myung Hwa Choi, Suwon (KR); Sang Hyun Kwon, Suwon (KR); Hyung Kyu Kim, Daejeon (KR)

(72) Inventors: Kun Kim, Suwon (KR); Myung Hwa Choi, Suwon (KR); Sang Hyun Kwon, Suwon (KR); Hyung Kyu Kim, Daejeon (KR)

(73) Assignee: SAMSUNG ELECTRO-MECHANICS CO., LTD.

(21) Appl. No.: 13/331,692

(22) Filed: Dec. 20, 2011

(30) Foreign Application Priority Data
Sep. 30, 2011 (KR) 10-2011-0099650

(51) Int. Cl. H02K 5/02; C09J 171/10; C09J 163/10

(52) U.S. Cl. 310/45; 525/530; 523/427; 522/103

(57) ABSTRACT

There are provided a sealing resin composition for a hard disk drive (HDD) motor and a HDD motor fabricated by using the same. The sealing resin composition includes 40 to 80 parts by weight of epichlorohydrin-4,4-isopropylidene diphenol resin; 5 to 20 parts by weight of acrylated ester; and 5 to 15 parts by weight of acrylated epoxy. The sealing resin composition containing a UV curable epoxy resin is used as a sealing material of the adhering part of the FPC of the HDD motor, whereby generation of outgas in the adhering part may be reduced.

### CROSS-REFERENCE TO RELATED APPLICATIONS

This application claims the priority of Korean Patent Application No. 10-2011-0099650 filed on Sep. 30, 2011, in the Korean Intellectual Property Office, the disclosure of which is incorporated herein by reference.

### BACKGROUND OF THE INVENTION

1. Field of the Invention

The present invention relates to a sealing resin composition for a hard disk drive (HDD) motor capable of securing reliable quality and improving workability by reducing generation of outgas, and a HDD motor fabricated by using the same.

2. Description of the Related Art

A hard disk drive (HDD), an information storage device, reads data stored on a disk or writes data to the disk using a read/write head.

The hard disk drive requires a disk driving device capable of driving the disk. In the disk driving device, a small-sized spindle motor is used.

This small-sized spindle motor has used a fluid dynamic bearing assembly. Lubricating fluid is interposed between shaft, a rotating member of the fluid dynamic bearing assembly, and a sleeve, a fixed member thereof, such that the shaft is supported by fluid pressure generated in the lubricating fluid.

Meanwhile, in fabricating the HDD motor, a sealing process has additionally been performed in a flexible printed circuit (FPC) adhering part of the motor in order to prevent air leaks (the leakage of air) and coil disconnection.

The sealing process is performed in order to secure reliable quality and to improve workability by reducing an outgas phenomenon in products.

However, in the case that a scheme of reinforcing sealing for the FPC adhering part using an ultraviolet curable adhesive material is used, it may be difficult to secure reliable quality due to the generation of outgas.

In addition, a high temperature process for curing is performed over a long period, thereby causing deterioration in workability efficiency.

Therefore, customer demand for securing reliable quality in the HDD motor has increased. Particularly, due to a defect in an outgas of a motor assembled by an adhesive, a complementary material, an error may occur in a storage function of the HDD. Therefore, a pre-test for securing quality reliability by quantitatively standardizing outgassing of an adhesive material has necessarily been emphasized before the mass-production of products.

### SUMMARY OF THE INVENTION

An aspect of the present invention provides a sealing resin composition for a hard disk drive (HDD) motor capable of securing reliable quality and improving workability by reducing a generation of outgas, and a HDD motor fabricated by using the same.

According to an aspect of the present invention, there is provided a sealing resin composition for a hard disk drive (HDD) including 40 to 80 parts by weight of epichlorohydrin-4,4-isopropylidene diphenol resin; 5 to 20 parts by weight of acrylated ester; and 5 to 15 parts by weight of acrylated epoxy.

The sealing resin composition may further include 5 to 20 parts by weight of an amine additive.

The sealing resin composition may further include 0.1 to 2 parts by weight of a photo initiator.

The sealing resin composition may be applied to an adhering part at which a flexible printed circuit (FPC) and a coil of the HDD motor are adhered to each other.

The adhering part may be a land part at which the coil is adhered to the FPC.

The acrylated epoxy may be an ultraviolet (UV) curable adhesive resin.

According to another aspect of the present invention, there is provided a HDD motor including a sealing resin composition applied to an adhering part between a FPC and a coil of the HDD motor and containing 40 to 80 parts by weight of epichlorohydrin-4,4-isopropylidene diphenol resin, 5 to 20 parts by weight of acrylated ester, and 5 to 15 parts by weight of acrylated epoxy.

The sealing resin composition may further include 5 to 20 parts by weight of an amine additive.

The sealing resin composition may further include 0.1 to 2 parts by weight of a photo initiator.

The acrylated epoxy may be an ultraviolet (UV) curable adhesive resin.

The adhering part may be a land part at which the coil is adhered to the FPC.

The adhering part may have an outgas concentration of 2000 ng/part or less.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic perspective view showing a HDD motor according to an embodiment of the present invention;

FIG. 2 is a schematic enlarged view of part A of FIG. 1 viewed from the bottom; and

FIG. 3 is a cross-sectional view taken along line B-B′ of FIG. 2.

### DETAILED DESCRIPTION OF THE INVENTION

Embodiments of the present invention may be modified in many different forms and the scope of the invention should not be limited to the embodiments set forth herein. Rather, these embodiments are provided so that this disclosure will be thorough and complete, and will fully convey the concept of the invention to those skilled in the art. In the drawings, the shapes and dimensions may be exaggerated for clarity, and the same reference numerals will be used throughout to designate the same or like components.

Embodiments of the present invention will now be described in detail with reference to the accompanying drawings.

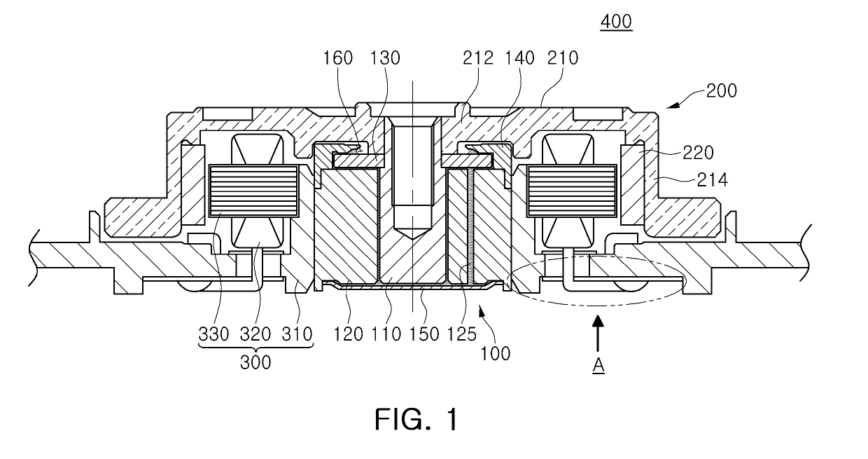

FIG. 1 is a schematic perspective view showing a HDD motor according to an embodiment of the present invention.

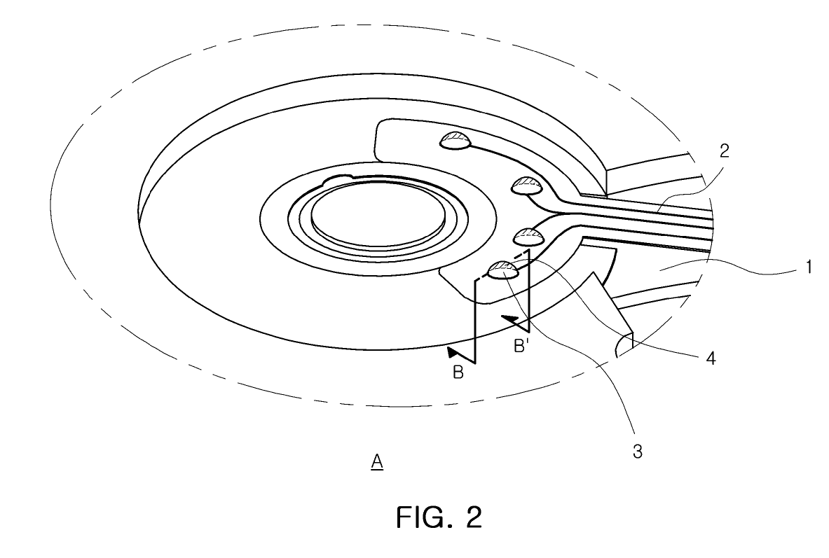

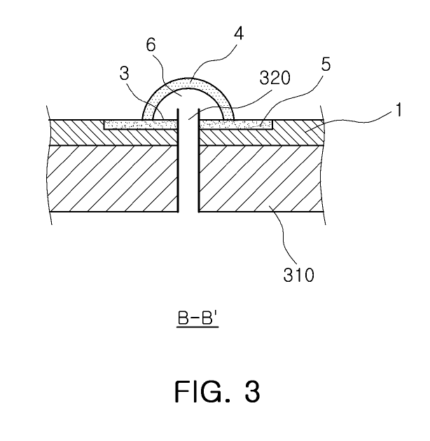

FIG. 2 is a schematic enlarged view of part A of FIG. 1 viewed from the bottom; and FIG. 3 is a cross-sectional view taken along line B-B′ of FIG. 2.

Referring to FIGS. 1 through 3, a sealing resin composition 4 for a HDD according to an embodiment of the present invention may include 40 to 80 parts by weight of epichlorohydrin-4,4-isopropylidene diphenol resin; 5 to 20 parts by weight of acrylated ester; and 5 to 15 parts by weight of acrylated epoxy.

Hereinafter, the above configuration will be described in detail.

The sealing resin composition 4 for a HDD motor according to the embodiment of the present invention may include 40 to 80 parts by weight of epichlorohydrin-4,4-isopropylidene diphenol resin.

When the epichlorohydrin-4,4-isopropylidene diphenol resin is applied to an adhering part 3 at which a flexible printed circuit (FPC) 1 and a coil 2 of a hard disk drive (HDD) motor to be described below are adhered to each other, it may serve to form a cured coating on the adhering part 3 and impart adhesion and a soldering in the adhering part 3.

A content of the epichlorohydrin-4,4-isopropylidene diphenol resin may be 40 to 80 parts by weight based on 100 parts by weight of sealing resin composition for a HDD motor. When the content of the epichlorohydrin-4,4-isopropylidene diphenol resin is less than 40 parts by weight, the adhesion may be reduced, and when the content of the epichlorohydrin-4,4-isopropylidene diphenol resin exceeds 80 parts by weight, outgas may be generated.

In addition, the sealing resin composition 4 for a HDD motor may include 5 to 20 parts by weight of acrylated ester.

The acrylated ester may serve to control viscosity of the sealing resin composition and workability.

A content of the acrylated ester may be 5 to 20 parts by weight based on 100 parts by weight of sealing resin composition for a HDD motor. When the content of the acrylated ester is less than 5 parts by weight, it may be difficult to control the viscosity and the workability, and when the content of the acrylated ester exceeds 20 parts by weight, an adhesion function may be deteriorated.

The sealing resin composition 4 for a HDD motor according to the embodiment of the present invention may include 5 to 15 parts by weight of acrylated epoxy.

According to the embodiment of the present invention, 5 to 15 parts by weight of acrylated epoxy may be added as an epoxy material, whereby reactivity according to a temperature may be improved and generation of outgas may be reduced.

Therefore, in the HDD motor fabricated using the sealing resin composition 4 for a HDD motor, the generation of the outgas is reduced, whereby reliable product quality may be secured and the workability may be improved.

The acrylated epoxy is not particularly limited but may be, for example, a UV curable adhesive resin.

A content of the acrylated epoxy may be 5 to 15 parts by weight based on 100 parts by weight of sealing resin composition for a HDD motor. When the content of the acrylated epoxy is less than 5 parts by weight, the effect of reducing the generation of the outgas may be relatively small, and when the content of the acrylated epoxy exceeds 15 parts by weight, a defect may occur in the workability.

The sealing resin composition 4 for a HDD motor according to the embodiment of the present invention may further include 5 to 20 parts by weight of an amine additive.

The amine additive may serve as a functional additive for improving an adhesion function of the sealing resin composition.

A content of the amine additive may be 5 to 20 parts by weight based on 100 parts by weight of sealing resin composition for a HDD motor. When the content of the amine additive is less than 5 parts by weight, the effect of improving the adhesion function may be relatively small, and when the content of the amine additive exceeds 20 parts by weight, a defect may occur in a physical property of the sealing resin composition and the workability due to addition of an excessive amount of amine additive.

The sealing resin composition 4 for a HDD motor according to the embodiment of the present invention may further include 0.1 to 2 parts by weight of a photo initiator.

The photo initiator may serve decompose and activate the acrylated epoxy resin by ultraviolet (UV) irradiation to generate polymerization, thereby curing the sealing resin composition.

A content of the photo initiator may be 0.1 to 2 parts by weight based on 100 parts by weight of sealing resin composition for a HDD motor. When the content of the photo initiator is less than 0.1 parts by weight, the polymerization is not generate, such that a defect that the sealing resin composition is not cured may occur, and when the content of the photo initiator exceeds 2 parts by weight, an excessive amount of photo initiator may have an influence on the physical property of the sealing resin composition.

The sealing resin composition 4 for a HDD motor according to the embodiment of the present invention may be applied to, for example, an adhering part at which a flexible printed circuit (FPC) and a coil of the HDD motor are adhered to each other, but is not particularly limited thereto.

The adhering part maybe a land part 5 at which the coil is adhered to the FPC.

A HDD motor according to another embodiment of the present invention may include a sealing resin composition applied to an adhering part between the FPC and the coil of a HDD motor and including 40 to 80 parts by weight of epichlorohydrin-4,4-isopropylidene diphenol resin; 5 to 20 parts by weight of acrylated ester; and 5 to 15 parts by weight of acrylated epoxy.

The adhering part may have an outgas concentration of 2000 ng/part or less.

Hereinafter, the HDD motor according to another embodiment of the present invention will be described in detail. However, a portion overlapped with the description in the above-mentioned embodiment of the present invention will be omitted.

In the HDD motor according to another embodiment of the present invention, a fixed member may be a sleeve 120 and a cap 140, and a rotating member may be a shaft 110, a thrust plate 130, and a hub 212.

In addition, the HDD motor may include an oil sealing part 160 formed between fixed members 120 and 140 and rotating members 110, 130, and 212, particularly, between the sleeve 120, the thrust plate 130, and the cap 140.

The cap 140 may be a member that is press-fitted onto an upper portion of the thrust plate 130 to thereby allow lubricating fluid to be sealed between the cap 140 and the thrust plate 130, and include a circumferential groove formed in an circumferential surface thereof so as to be press-fitted into the thrust plate 130 and the sleeve 120.

The cap 140 may include a protrusion part formed on a lower surface thereof in order to seal the lubricating fluid, which uses a capillary phenomenon and a surface tension of the lubricating fluid in order to prevent the lubricating fluid from being leaked to the outside at the time of driving of the motor.

Meanwhile, a HDD motor 400 according to another embodiment of the present invention may include a shaft 110, the sleeve 120, the thrust plate 130, the cap 140, and the oil sealing part 160.

The sleeve 120 may support the shaft 110 so that an upper end of the shaft 110 protrudes upwardly in an axial direction, and may be formed by forging copper (Cu) or aluminum (Al) or sintering copper-iron (Cu—Fe) based alloy powders or SUS based powders.

Here, the shaft 110 may be inserted into a shaft hole of the sleeve 120 so as to have a micro clearance therewith. The micro clearance may be filled with the lubricating fluid, and the rotation of a rotor 200 may be more smoothly supported by a radial dynamic groove formed in at least one of an outer circumferential surface of the shaft 110 and an inner circumferential surface of the sleeve 120.

The radial dynamic groove maybe formed in an inner side of the sleeve 120, which is an inner portion of the shaft hole of the sleeve 120, and may generate pressure so as to be deflected toward one side at the time of rotation of the shaft 110.

However, the radial dynamic groove is not limited to being formed in the inner side of the sleeve 120 as described above but may also be formed in an outer circumferential surface portion of the shaft 110. In addition, the number of radial dynamic grooves is not limited.

The sleeve 120 may include a bypass channel 125 formed therein in order to allow upper and lower portions thereof to be communication with each other to disperse pressure of the lubricating fluid in an inner portion of a fluid dynamic bearing assembly 100, thereby maintaining balance in the pressure, and may move air bubbles, or the like, present in the inner portion of the fluid dynamic bearing assembly 100 so as to be discharged by circulation.

Here, the sleeve 120 may include a cover plate 150 coupled to a lower portion thereof, having a clearance therebetween, wherein the clearance receives the lubricating fluid therein.

The cover plate 150 may receive the lubricating fluid in the clearance between the cover plate 150 and the sleeve 120 to thereby serve as a bearing supporting a lower surface of the shaft 110.

The thrust plate 130 maybe disposed on an upper portion of the sleeve 120 in the axial direction and includes a hole formed at the center thereof, wherein the hole is formed to correspond to a cross section of the shaft 110. The shaft 110 may be inserted into this hole.

Here, the thrust plate 130 maybe separately fabricated and then coupled to the shaft 110. However, the thrust plate 130 may be formed integrally with the shaft 110 at the time of fabricating thereof and may rotate together with the shaft 110 at the time of the rotation of the shaft 110.

In addition, the thrust plate 130 may include a thrust dynamic groove formed in an upper surface thereof, wherein the thrust dynamic groove provides thrust dynamic pressure to the shaft 110.

The thrust dynamic groove is not limited to being formed in the upper surface of the thrust plate 130 as described above but may also be formed in an upper surface of the sleeve 120 corresponding to a lower surface of the thrust plate 130.

The stator 300 may include a coil 320, a core 330, and a base member 310.

In other words, the stator 300 may be a fixed structure including the coil 320 generating electromagnetic force having a predetermined magnitude at the time of application of power and a plurality of cores 330 having the coil 320 wound therearound.

The core 330 maybe fixedly disposed on an upper portion of the base member 310 including a FPC 1 having pattern circuits 2 printed thereon, a plurality of coil holes having a predetermined size may be formed to penetrate through the base member 310 so as to expose the coil 320 downwardly, penetrating a portion of the base member 310 corresponding to the coil 320, and the coil 320 may be electrically connected to the FPC 1 so that external power is supplied thereto.

An outer peripheral surface of the sleeve 120 may be press-fitted into the base member 310 to thereby be fixed thereto, and the core 330 having the coil 320 wound therearound maybe inserted into the base member 310. In addition, the base member 310 and the sleeve 120 may be assembled with each other by applying an adhesive to an inner surface of the base member 310 or an outer surface of the sleeve 120.

The rotor 200, which is a rotational structure rotatably provided with respect to the stator 300, may include a rotor case 210 having an annular ring shaped magnet 220 provided on an outer peripheral surface thereof, wherein the annular ring shaped magnet 220 corresponds to the core 330, having a predetermined interval therebetween.

Here, as the magnet 220, a permanent magnet generating magnetic force having predetermined strength by alternately magnetizing an N pole and an S pole thereof in a circumferential direction may be used.

Here, the rotor case 210 may include a hub base 212 press-fitted into the upper end of the shaft 110 to thereby be fixed thereto and a magnet support part 214 extended from the hub base 212 in an outer diameter direction and bent downwardly in the axial direction to thereby support the magnet 220.

The HDD motor according to another embodiment of the present invention may include a sealing resin composition applied to the adhering part between the FPC and the coil of the HDD motor and including 40 to 80 parts by weight of epichlorohydrin-4,4-isopropylidene diphenol resin; 5 to 20 parts by weight of acrylated ester; and 5 to 15 parts by weight of acrylated epoxy.

As described above, the composition includes 5 to 15 parts by weight of acrylated epoxy, whereby the generation of the outgas may be reduced. Therefore, the reliable HDD motor quality may be secured.

In addition, the acrylated epoxy resin is used, whereby the workability may be improved.

A fabricating method of the HDD motor 400 may be the same as a general fabricating method except that the sealing resin composition 4 according to the embodiment of the present invention is applied to the adhering part 3 at which the FPC 1 and the coil 2 of the HDD motor are adhered to each other to thereby adhere the FPC 1 and the coil 2 to each other.

The following Table 1 is a table in which contents of each component and amounts of outgas of the HDD motor fabricated by applying the sealing resin composition according to the embodiment of the present invention are compared with those of the HDD motor fabricated using a sealing resin composition according to the related art that does not contain the acrylated epoxy resin.

More specifically, in Inventive Example 1, a sealing resin composition was prepared to contain 60 parts by weight of epichlorohydrin-4,4-isopropylidene diphenol resin, 10 parts by weight of acrylated ester, 10 parts by weight of acrylated epoxy, 10 parts by weight of an amine additive, and 1 part by weight of a photo initiator.

In Inventive Example 2, a sealing resin composition was prepared to contain 80 parts by weight of epichlorohydrin-4,4-isopropylidene diphenol resin, 15 parts by weight of acrylated ester, 15 parts by weight of acrylated epoxy, 10 parts by weight of an amine additive, and 2 parts by weight of a photo initiator.

Meanwhile, in Comparative Example 1, a sealing resin composition was prepared to contain 55 parts by weight of modified acrylate, 45 parts by weight of high boiling point acrylate, 0.5 parts by weight of silane coupling agent, 3 parts by weight of organic hydroperoxide, and 2 parts by weight of a photo initiator.

In Comparative Example 2, a sealing resin composition was prepared to contain 65 parts by weight of modified acrylate, 50 parts by weight of high boiling point acrylate, 1.0 part by weight of silane coupling agent, 3 parts by weight of organic hydroperoxide, and 2 parts by weight of a photo initiator.

Each component was analyzed by a gas chromatography-mass spectroscopy (GC-MS) analysis. Data on the analysis is shown in the following Table 1.

TABLE 1

| | Comparative Example | | | Inventive Example | | |
|---|---|---|---|---|---|---|
| | (ng/part) | | | (ng/part) | | |
| Component | 1 | 2 | Average | 1 | 2 | Average |
| Acrylate and | — | — | — | 33 | 17 | 25 |
| Methacrylate | | | | | | |
| Aliphatic | 28 | 10 | 19 | — | — | — |
| Hhydrocarbon | | | | | | |
| Aromatic | 14 | 7 | 10 | 30 | 27 | 29 |
| Hydrocarbon | | | | | | |
| Initiator | 150 | 103 | 127 | 23 | — | 23 |
| Antioxidant | 144 | 224 | 184 | 94 | 89 | 92 |
| Organic | 9 | 16 | 13 | — | — | — |
| Sulfide | | | | | | |
| Phenol | 47 | 47 | 47 | — | — | — |
| Phthalate | 46 | 79 | 63 | 69 | 59 | 64 |
| Alcohol | 1 | 11 | 6 | 70 | 63 | 67 |
| Other | 344 | 467 | 406 | 1,177 | 1,088 | 1,133 |
| Components | | | | | | |
| Outgas | 1,106 | 1,204 | 1,155 | 2,963 | 2,926 | 2,945 |

It could be appreciated that in the case of Inventive Examples 1 and 2, acrylate and methacrylate were not detected at all, and a total detected amount of outgas was reduced to a level 2.5 times lower than those of Comparative Examples.

Therefore, the HDD motor fabricated by applying the sealing resin composition according to the embodiment of the present invention may reduce the generation of the outgas, whereby improved reliable HDD motor quality may be secured and workability may be improved.

Here, terms with respect to directions will be defined. As viewed in FIG. 1, an axial direction refers to a vertical direction based on a shaft 11, and an outer diameter or an inner diameter direction refers to a direction towards an outer edge of a rotor 40 based on the shaft 11 or a direction towards the center of the shaft 11 based on the outer edge of the rotor 40

As set forth above, according to the embodiments of the present invention, the sealing resin composition including the UV curable epoxy resin may be used as a sealing material of the adhering part of the FPC of the HDD motor, whereby the generation of the outgas in the adhering part may be reduced. Therefore, the improved reliable HDD motor quality may be provided and the workability may be improved.

While the present invention has been shown and described in connection with the embodiments, it will be apparent to those skilled in the art that modifications and variations can be made without departing from the spirit and scope of the invention as defined by the appended claims.

What is claimed is:

1. A sealing resin composition for a hard disk drive (HDD) comprising:
40 to 80 parts by weight of epichlorohydrin-4,4-isopropylidene diphenol resin;
5 to 20 parts by weight of acrylated ester; and
5 to 15 parts by weight of acrylated epoxy.

2. The sealing resin composition of claim 1, further comprising 5 to 20 parts by weight of an amine additive.

3. The sealing resin composition of claim 1, further comprising 0.1 to 2 parts by weight of a photo initiator.

4. The sealing resin composition of claim 1, wherein the sealing resin composition is applied to an adhering part at which a flexible printed circuit (FPC) and a coil of the HDD motor are adhered to each other.

5. The sealing resin composition of claim 4, wherein the adhering part is a land part at which the coil is adhered to the FPC.

6. The sealing resin composition of claim 1, wherein the acrylated epoxy is an ultraviolet (UV) curable adhesive resin.

7. A HDD motor comprising:
a sealing resin composition applied to an adhering part between a FPC and a coil of the HDD motor and including 40 to 80 parts by weight of epichlorohydrin-4,4-isopropylidene diphenol resin, 5 to 20 parts by weight of acrylated ester, and 5 to 15 parts by weight of acrylated epoxy.

8. The HDD motor of claim 7, wherein the sealing resin composition further includes 5 to 20 parts by weight of an amine additive.

9. The HDD motor of claim 7, wherein the sealing resin composition further includes 0.1 to 2 parts by weight of a photo initiator.

10. The HDD motor of claim 7, wherein the acrylated epoxy is an ultraviolet (UV) curable adhesive resin.

11. The HDD motor of claim 7, wherein the adhering part is a land part at which the coil is adhered to the FPC.

12. The HDD motor of claim 7, wherein the adhering part has an outgas concentration of 2000 ng/part or less.
